(19) United States
(12) Patent Application Publication
(10) Pub. No.: US 2024/0372146 A1
(43) Pub. Date: Nov. 7, 2024

(54) ELECTROLYTIC SOLUTION FOR SECONDARY BATTERY, AND SECONDARY BATTERY

(71) Applicant: MURATA MANUFACTURING CO., LTD., Kyoto (JP)

(72) Inventor: Kentaro YOSHIMURA, Kyoto (JP)

(21) Appl. No.: 18/775,331

(22) Filed: Jul. 17, 2024

Related U.S. Application Data
(63) Continuation of application No. PCT/JP2023/005460, filed on Feb. 16, 2023.

(30) Foreign Application Priority Data
Mar. 28, 2022 (JP) 2022-051590

(51) Int. Cl. H01M 10/0567; H01M 10/0525

(52) U.S. Cl. CPC H01M 10/0567; H01M 10/0525; H01M 2300/0025

(57) ABSTRACT

A secondary battery includes a positive electrode, a negative electrode, and an electrolytic solution. The electrolytic solution includes a fluorine-containing aromatic ring compound. The fluorine-containing aromatic ring compound includes a center part, one or more trifluoromethyl groups (—CF₃), and one or more introduction groups. The center part includes one or more benzene rings. The one or more trifluoromethyl groups are introduced into the center part. The one or more introduction groups are introduced into the center part. Each of the one or more introduction groups is any one of an amino-type group (—NR₂ where each of two R's is either a hydrogen group or a methyl group), a nitro group (—NO₂), a cyano group (—CN), or an isocyanate group (—NCO).

### CROSS REFERENCE TO RELATED APPLICATIONS

The present application is a continuation of PCT patent application no. PCT/JP2023/005460, filed on Feb. 16, 2023, which claims priority to Japanese patent application no. 2022-051590, filed on Mar. 28, 2022, the entire contents of which are incorporated herein by reference.

### BACKGROUND

The present technology relates to an electrolytic solution for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution (an electrolytic solution for a secondary battery). A configuration of the secondary battery has been considered in various ways.

Specifically, an electrolytic solution includes, for example, a carbonic acid ester of alcohol having a specific structure. An electrolytic solution includes a compound having a specific aromatic linking group.

### SUMMARY

The present technology relates to an electrolytic solution for a secondary battery, and a secondary battery.

Although consideration has been given in various ways regarding a configuration of a secondary battery, a battery characteristic of the secondary battery is not sufficient yet. Accordingly, there is room for improvement in terms thereof.

It is desirable to provide an electrolytic solution for a secondary battery and a secondary battery each of which makes it possible to achieve a superior battery characteristic.

An electrolytic solution for a secondary battery according to an embodiment of the present technology includes a fluorine-containing aromatic ring compound. The fluorine-containing aromatic ring compound includes a center part, one or more trifluoromethyl groups (—CF₃), and one or more introduction groups. The center part includes one or more benzene rings. The one or more trifluoromethyl groups are introduced into the center part. The one or more introduction groups are introduced into the center part. Each of the one or more introduction groups is any one of an amino-type group (—NR₂ where each of two R's is either a hydrogen group or a methyl group), a nitro group (—NO₂), a cyano group (—CN), or an isocyanate group (—NCO).

A secondary battery according to an embodiment of the present technology includes a positive electrode, a negative electrode, and an electrolytic solution. The electrolytic solution has a configuration similar to that of the electrolytic solution for a secondary battery according to the embodiment of the present technology described above.

According to the electrolytic solution for a secondary battery or the secondary battery of the embodiment of the present technology, the electrolytic solution for a secondary battery includes the fluorine-containing aromatic ring compound. Accordingly, it is possible to achieve a superior battery characteristic.

Note that effects of the present technology are not necessarily limited to those described herein and may include any of a series of effects described below in relation to the present technology.

### BRIEF DESCRIPTION OF THE FIGURES

FIG. 1 is a sectional view of a configuration of a secondary battery according to an embodiment of the present technology.

FIG. 2 is a sectional view of a configuration of a battery device illustrated in FIG. 1.

FIG. 3 is a block diagram illustrating a configuration of an application example of the secondary battery.

### DETAILED DESCRIPTION

The present technology is described below in further detail including with reference to the drawings according to an embodiment.

A description is given first of an electrolytic solution for a secondary battery (hereinafter simply referred to as an “electrolytic solution”) according to an embodiment of the present technology.

The electrolytic solution described here is a liquid electrolyte to be used in a secondary battery, which is an electrochemical device. However, the electrolytic solution may be used in other electrochemical devices besides the secondary battery. Specific examples of the other electrochemical devices include a capacitor.

The electrolytic solution includes any one or more of fluorine-containing aromatic ring compounds. The fluorine-containing aromatic ring compound includes a center part that is a skeleton, a trifluoromethyl group (—CF₃) introduced into the center part, and an introduction group introduced into the center part.

A reason why the electrolytic solution includes the fluorine-containing aromatic ring compound is that upon charging and discharging of the secondary battery including the electrolytic solution, a satisfactory film derived from the fluorine-containing aromatic ring compound is formed on a surface of an electrode. In this case, when a solvent such as a carbonic-acid-ester-based compound, which will be described later, is decomposed on the surface of the electrode, the center part (a benzene ring, which will be described later) into which the trifluoromethyl group is introduced is also decomposed, which causes a film to be formed. The film has an electrochemically stable property and thus serves as a protective film that protects the surface of the electrode.

This suppresses a decomposition reaction of the electrolytic solution on the surface of the electrode, which reduces a decrease in a discharge capacity even upon repeated charging and discharging. In this case, in particular, the film has superior durability. This effectively reduces a decrease in the discharge capacity even if the secondary battery is used, i.e., charged and discharged, and stored in a high-temperature environment.

Details of a configuration of the fluorine-containing aromatic ring compound are as described below according to an embodiment.

The center part includes a benzene ring as an aromatic compound (an aromatic hydrocarbon). The number of benzene rings may be only one, or two or more.

When the number of benzene rings is two or more, a configuration (a linkage state) of the two or more benzene rings is not particularly limited. Accordingly, the two or more benzene rings may be indirectly bonded to each other via a single bond or indirectly bonded to each other via a linking group. The two or more benzene rings may be directly bonded to each other, that is, condensed to each other.

Specifically, for example, when the number of benzene rings is two, the configuration of the two benzene rings may be any of configurations to be described below.

First, the two benzene rings may be indirectly bonded to each other via a single bond, and the center part may thus be biphenyl (C₆H₅—C₆H₅).

Second, the two benzene rings may be indirectly bonded to each other via an ether bond (—O—) as a linking group, and the center part may thus be diphenyl ether (C₆H₅—O—C₆H₅).

The linking group is not particularly limited in kind as long as it is a divalent group. Specifically, the linking group may be, for example, a thio bond (—S—) besides the ether bond.

Third, the two or more benzene rings may be directly bonded to each other, that is, condensed to each other, and the center part may thus be naphthalene (C₁₀H₈).

The trifluoromethyl group is introduced into the center part as described above. Thus, a hydrogen group in the center part is substituted with the trifluoromethyl group.

The number of trifluoromethyl groups may be only one, or two or more. When the number of benzene rings included in the center part is two or more, the trifluoromethyl group may be introduced into only one of the benzene rings, may be introduced into each of the two or more benzene rings, or may be introduced into each of more than one, but not all, of the two or more benzene rings.

The introduction group is introduced into the center part as described above. Thus, a hydrogen group in the center part is substituted with the introduction group.

The number of introduction groups may be only one, or two or more. When the number of benzene rings included in the center part is two or more, the introduction group may be introduced into only one of the benzene rings, may be introduced into each of the two or more benzene rings, or may be introduced into each of more than one, but not all, of the two or more benzene rings.

The introduction group is a specific group that is different from the trifluoromethyl group. Specifically, the introduction group is any one of an amino-type group (—NR₂ where each of two R's is either a hydrogen group or a methyl group), a nitro group (—NO₂), a cyano group (—CN), or an isocyanate group (—NCO). The amino-type group may be an amino group (—NH₂), a methylamino group (—NHCH₃), or a dimethylamino group (—N(CH₃)₂).

In particular, the introduction group is preferably either the amino-type group or the nitro group. A reason for this is that this makes it easier for the film derived from the fluorine-containing aromatic ring compound to be formed.

When the number of introduction groups is two or more, respective kinds of the two or more introduction groups may be the same as or different from each other. It goes without saying that respective kinds of only some of the two or more introduction groups may be the same as each other.

Here, as described above, the number of trifluoromethyl groups is one or more and the number of introduction groups is one or more. The fluorine-containing aromatic ring compound therefore includes one or more trifluoromethyl groups and one or more introduction groups.

Accordingly, a compound including one or more trifluoromethyl groups but not including one or more introduction groups is excluded from the fluorine-containing aromatic ring compound described here. Further, a compound including one or more introduction groups but not including one or more trifluoromethyl groups is excluded from the fluorine-containing aromatic ring compound described here.

In particular, when the center part includes two or more benzene rings, it is preferable that each of the trifluoromethyl group and the introduction group be bonded to each of the two or more benzene rings. A reason for this is that this makes it easier for the film derived from the fluorine-containing aromatic ring compound to be formed.

In this case, the number of trifluoromethyl groups bonded to each of the two or more benzene rings may be only one, or two or more. Similarly, the number of introduction groups bonded to each of the two or more benzene rings may be only one, or two or more.

Note that the fluorine-containing aromatic ring compound may further include any one or more of additional groups introduced into the center part. The additional group is introduced into the center part as described above. Thus, a hydrogen group in the center part is substituted with the additional group.

The additional group is different from each of the trifluoromethyl group and the introduction group. The number of additional groups may be only one, or two or more.

The additional group is not particularly limited in kind, and specific examples thereof include an alkyl group, an alkoxy group (—OR where R is an alkyl group), a fluorine group (—F), an amino-modified group (—NHX where X is an acyl group), a carboxylic acid ester group (—C(═O)OR where R is an alkyl group), and a sodium sulfate group (—SO₃Na). Note that examples of the alkyl group include a methyl group (—CH₃) and an ethyl group (—C₂H₅). Examples of the acyl group include an acetyl group (—C(═O)CH₃), an isobutanoyl group (—C(═O)CH(CH₃)₂), a propanoyl group (—C(═O)C₂H₅), a butanoyl group (—C(═O)C₃H₇), a pivaloyl group (—C(═O)C(CH₃)₃), and a benzoyl group (—C(═O)C₆H₅).

### Specific Examples

Specific examples of the fluorine-containing aromatic ring compound include respective compounds represented by Formulae (1) to (41).

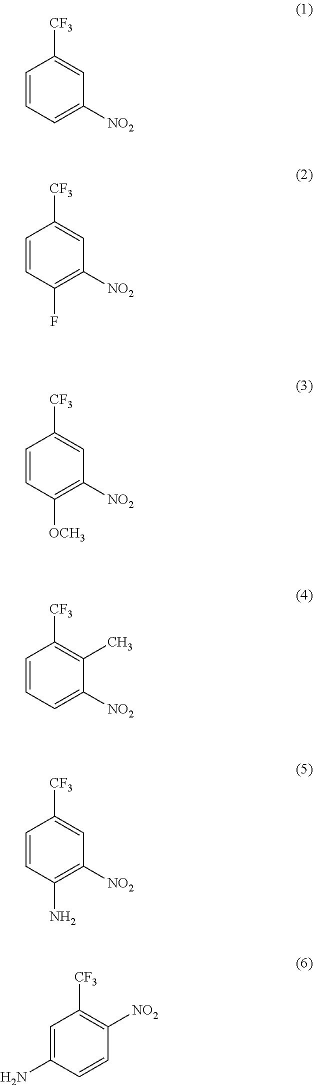

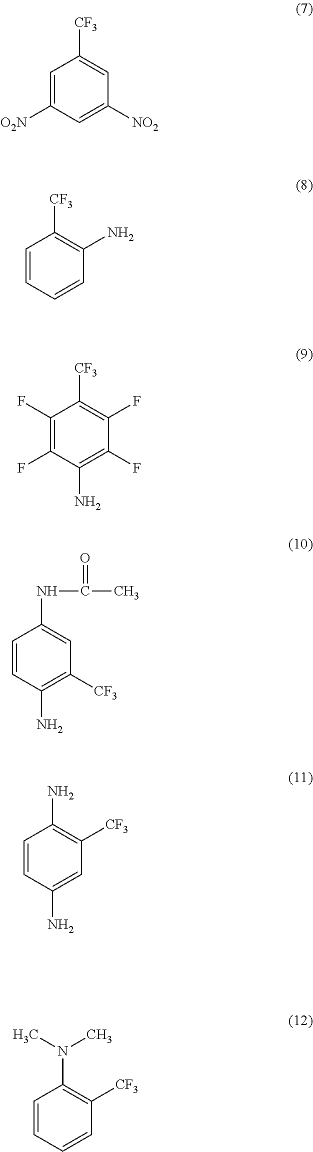 [SMILES: O=[N+]([O-])c1cc([N+](=O)[O-])cc(C(F)(F)F)c1 ; Nc1ccccc1C(F)(F)F ; Nc1c(F)c(F)c(C(F)(F)F)c(F)c1F ; CC(=O)Nc1ccc(N)c(C(F)(F)F)c1 ; Nc1ccc(N)c(C(F)(F)F)c1 ; CN(C)c1ccccc1C(F)(F)F]

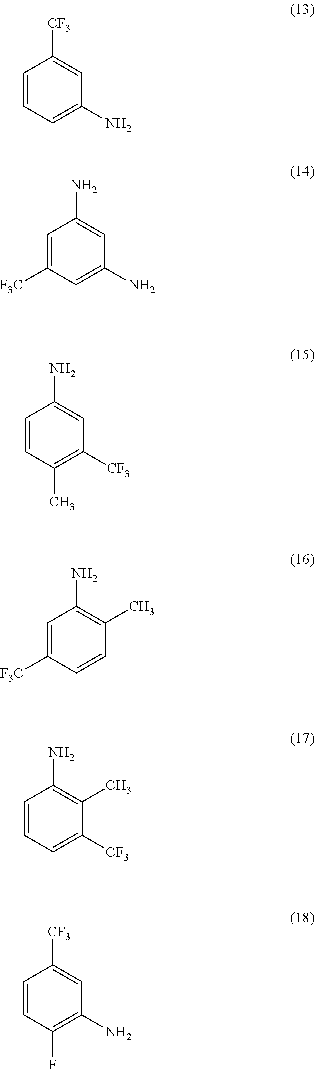

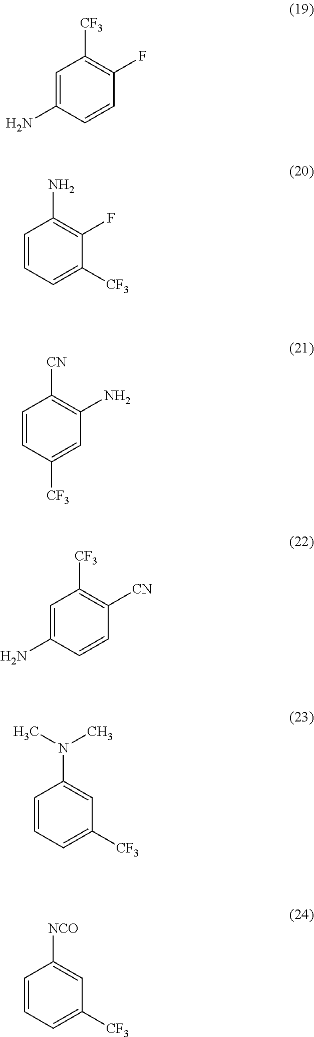

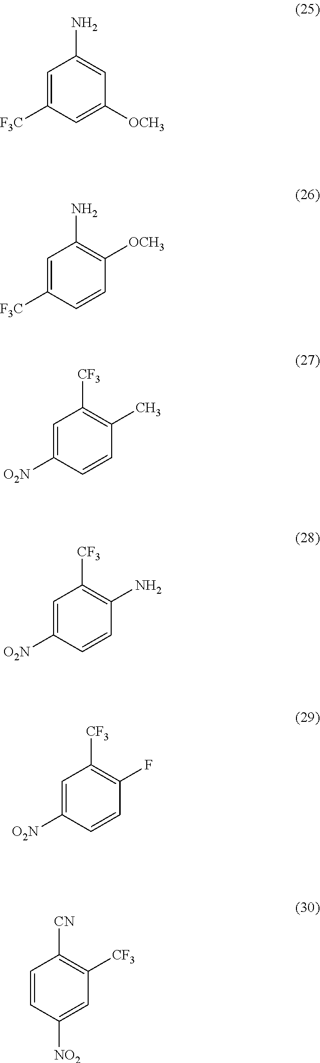

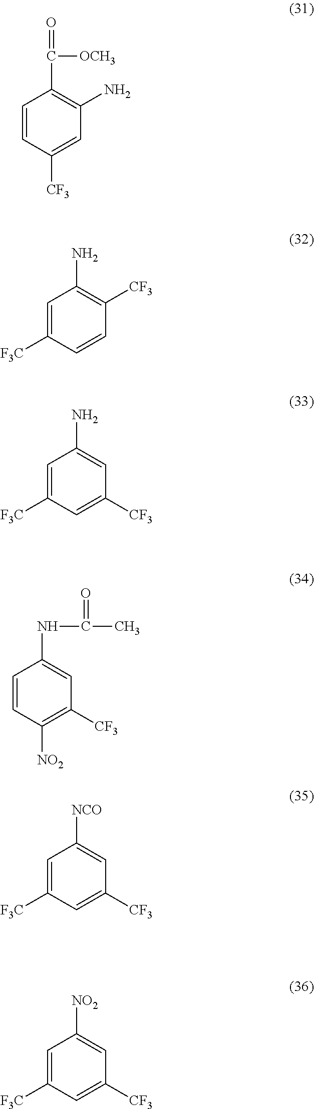

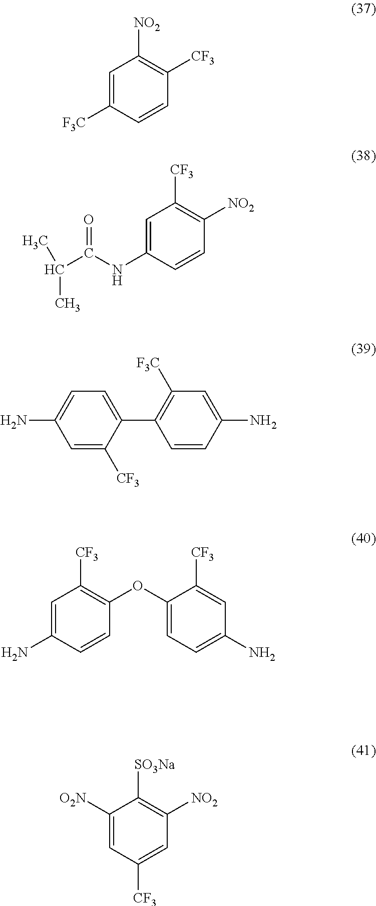

A content of the fluorine-containing aromatic ring compound in the electrolytic solution is not particularly limited, and is preferably within a range from 0.5 wt % to 2.0 wt % both inclusive, in particular. A reason for this is that this makes it easier for the film derived from the fluorine-containing aromatic ring compound to be formed.

When measuring the content of the fluorine-containing aromatic ring compound, the electrolytic solution is analyzed to thereby calculate the content of the fluorine-containing aromatic ring compound. When using a secondary battery including the electrolytic solution, the secondary battery is disassembled to thereby collect the electrolytic solution, following which the electrolytic solution is analyzed. A method of analyzing the electrolytic solution is not particularly limited, and specifically includes any one or more of methods including, without limitation, inductively coupled plasma (ICP) optical emission spectroscopy, nuclear magnetic resonance (NMR) spectroscopy, and gas chromatography mass spectrometry (GC-MS).

Note that the electrolytic solution may further include a solvent. The solvent includes any one or more of non-aqueous solvents (organic solvents), and the electrolytic solution including the one or more non-aqueous solvents is what is called a non-aqueous electrolytic solution.

The non-aqueous solvent is, for example, an ester or an ether, more specifically, the carbonic-acid-ester-based compound, a carboxylic-acid-ester-based compound, or a lactone-based compound, for example.

The carbonic-acid-ester-based compound is, for example, a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include methyl acetate, ethyl acetate, methyl propionate, ethyl propionate, propyl propionate, ethyl trimethylacetate, methyl butyrate, and ethyl butyrate.

The lactone-based compound is, for example, a lactone. Specific examples of the lactone include γ-butyrolactone and γ-valerolactone.

Note that the ether may be, for example, 1,2-dimethoxyethane, tetrahydrofuran, 1,3-dioxolane, or 1,4-dioxane.

It is preferable that the non-aqueous solvent include a high-dielectric-constant solvent having a specific dielectric constant of greater than or equal to 20 at a temperature within a range of higher than or equal to −30° C. and lower than 60° C. A reason for this is that a high battery capacity is obtainable in the secondary battery including the electrolytic solution. The high-dielectric-constant solvent is a cyclic compound such as the cyclic carbonic acid ester or the lactone described above. Note that a chain compound such as the chain carbonic acid ester or the chain carboxylic acid ester described above is a low-dielectric-constant solvent having a specific dielectric constant that is smaller than the specific dielectric constant of the high-dielectric-constant solvent.

In particular, it is preferable that the high-dielectric-constant solvent include the lactone, and a proportion R of a weight W2 of the lactone to a weight W1 of the high-dielectric-constant solvent be within a range from 30 wt % to 100 wt % both inclusive. A reason for this is that, even if the secondary battery including the electrolytic solution is charged and discharged, a decrease in the discharge capacity is reduced and gas generation due to the decomposition reaction of the electrolytic solution is also suppressed. The proportion R is calculated based on the following calculation expression: proportion R (wt %)=(W2/W1)×100.

Note that, when calculating the proportion R, the electrolytic solution is analyzed to thereby identify kinds of respective components included in the electrolytic solution and the contents (the weight W1 and the weight W2), following which the proportion R is calculated. A method of analyzing the electrolytic solution is not particularly limited, and is specifically similar to that used when measuring the content of the fluorine-containing aromatic ring compound in the electrolytic solution.

In addition, the electrolytic solution may further include an electrolyte salt. The electrolyte salt is a light metal salt such as a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium difluorooxalatoborate (LiBF₂(C₂O₄)), lithium difluorodi(oxalato)borate (LiBF₂(C₂O₄)₂), lithium tetrafluorooxalatophosphate (LiPF₄(C₂O₄)), lithium monofluorophosphate (Li₂PFO₃), and lithium difluorophosphate (LiPF₂O₂).

A content of the electrolyte salt is not particularly limited, and is specifically within a range from 0.3 mol/kg to 3.0 mol/kg both inclusive. A reason for this is that a high ion conductive property is obtainable.

Note that the electrolytic solution may further include any one or more of additives.

Specifically, the additives include any one or more of an unsaturated cyclic carbonic acid ester, a fluorinated cyclic carbonic acid ester, or a cyanated cyclic carbonic acid ester. A reason for this is that this improves electrochemical stability of the electrolytic solution. This further suppresses the decomposition reaction of the electrolytic solution upon charging and discharging of the secondary battery, which further reduces a decrease in the discharge capacity even upon repeated charging and discharging.

The unsaturated cyclic carbonic acid ester is a cyclic carbonic acid ester having an unsaturated carbon bond (a carbon-carbon double bond). The number of unsaturated carbon bonds is not particularly limited, and may be only one, or two or more.

The unsaturated cyclic carbonic acid ester includes any one or more of a vinylene-carbonate-based compound, a vinyl-ethylene-carbonate-based compound, or a methylene-ethylene-carbonate-based compound.

The vinylene-carbonate-based compound is an unsaturated cyclic carbonic acid ester having a structure of a vinylene carbonate type. Specific examples of the vinylene-carbonate-based compound include vinylene carbonate (1,3-dioxol-2-one), methyl vinylene carbonate (4-methyl-1,3-dioxol-2-one), ethyl vinylene carbonate (4-ethyl-1,3-dioxol-2-one), 4,5-dimethyl-1,3-dioxol-2-one, 4,5-diethyl-1,3-dioxol-2-one, 4-fluoro-1,3-dioxol-2-one, and 4-trifluoromethyl-1,3-dioxol-2-one.

The vinyl-ethylene-carbonate-based compound is an unsaturated cyclic carbonic acid ester having a structure of a vinyl ethylene carbonate type. Specific examples of the vinyl-ethylene-carbonate-based compound include vinyl ethylene carbonate (4-vinyl-1,3-dioxolane-2-one), 4-methyl-4-vinyl-1,3-dioxolane-2-one, 4-ethyl-4-vinyl-1,3-dioxolane-2-one, 4-n-propyl-4-vinyl-1,3-dioxolane-2-one, 5-methyl-4-vinyl-1,3-dioxolane-2-one, 4,4-divinyl-1,3-dioxolane-2-one, and 4,5-divinyl-1,3-dioxolane-2-one.

The methylene-ethylene-carbonate-based compound is an unsaturated cyclic carbonic acid ester having a structure of a methylene ethylene carbonate type. Specific examples of the methylene-ethylene-carbonate-based compound include methylene ethylene carbonate (4-methylene-1,3-dioxolane-2-one), 4,4-dimethyl-5-methylene-1,3-dioxolane-2-one, and 4,4-diethyl-5-methylene-1,3-dioxolane-2-one. Here, a compound including only one methylene group is given as an example of the methylene-ethylene-carbonate-based compound; however, the methylene-ethylene-carbonate-based compound may include two or more methylene groups.

Note that the cyclic carbonic acid ester having an unsaturated carbon bond belongs to neither the fluorinated cyclic carbonic acid ester nor the cyanated cyclic carbonic acid ester, but belongs to the unsaturated cyclic carbonic acid ester.

The fluorinated cyclic carbonic acid ester is a cyclic carbonic acid ester including fluorine as a constituent element. The number of fluorine atoms is not particularly limited and may be only one, or two or more. That is, the fluorinated cyclic carbonic acid ester is a compound resulting from substituting one or more hydrogen atoms of the cyclic carbonic acid ester with one or more fluorine atoms.

Specific examples of the fluorinated cyclic carbonic acid ester include fluoroethylene carbonate (4-fluoro-1,3-dioxolane-2-one) and difluoroethylene carbonate (4,5-difluoro-1,3-dioxolane-2-one).

Note that the cyclic carbonic acid ester including fluorine as a constituent element belongs to neither the unsaturated cyclic carbonic acid ester nor the cyanated cyclic carbonic acid ester, but belongs to the fluorinated cyclic carbonic acid ester.

The cyanated cyclic carbonic acid ester is a cyclic carbonic acid ester including a cyano group. The number of cyano groups is not particularly limited and may be only one, or two or more. That is, the cyanated cyclic carbonic acid ester is a compound resulting from substituting one or more hydrogen atoms of the cyclic carbonic acid ester with one or more cyano groups.

Specific examples of the cyanated cyclic carbonic acid ester include cyanoethylene carbonate (4-cyano-1,3-dioxolane-2-one) and dicyanoethylene carbonate (4,5-dicyano-1,3-dioxolane-2-one).

Note that the cyclic carbonic acid ester including a cyano group belongs to neither the unsaturated cyclic carbonic acid ester nor the fluorinated cyclic carbonic acid ester, but belongs to the cyanated cyclic carbonic acid ester.

Further, the additives include any one or more of a sulfonic acid ester, a sulfuric acid ester, a sulfurous acid ester, a dicarboxylic acid anhydride, a disulfonic acid anhydride, or a sulfonic acid carboxylic acid anhydride. A reason for this is that this improves electrochemical stability of the electrolytic solution. This further suppresses the decomposition reaction of the electrolytic solution upon charging and discharging of the secondary battery, which further reduces a decrease in the discharge capacity even upon repeated charging and discharging.

Specific examples of the sulfonic acid ester include 1,3-propane sultone, 1-propene-1,3-sultone, 1,4-butane sultone, 2,4-butane sultone, and methanesulfonate propargyl ester.

Specific examples of the sulfuric acid ester include 1,3,2-dioxathiolane 2,2-dioxide, 1,3,2-dioxathiane 2,2-dioxide, and 4-methylsulfonyloxymethyl-2,2-dioxo-1,3,2-dioxathiolane.

Specific examples of the sulfurous acid ester include 1,3-propane sultone, 1-propene-1,3-sultone, 1,4-butane sultone, 2,4-butane sultone, and methanesulfonate propargyl ester. Specific examples of the sulfurous acid ester include 1,3,2-dioxathiolane 2-oxide and 4-methyl-1,3,2-dioxathiolane 2-oxide.

Specific examples of the dicarboxylic acid anhydride include 1,4-dioxane-2,6-dione, succinic anhydride, and glutaric anhydride.

Specific examples of the disulfonic acid anhydride include 1,2-ethanedisulfonic anhydride, 1,3-propanedisulfonic anhydride, and hexafluoro 1,3-propanedisulfonic anhydride.

Specific examples of the sulfonic acid carboxylic acid anhydride include 2-sulfobenzoic anhydride and 2,2-dioxooxathiolane-5-one.

Further, the additives include a nitrile compound. A reason for this is that this improves electrochemical stability of the electrolytic solution. This further suppresses the decomposition reaction of the electrolytic solution upon charging and discharging of the secondary battery, which further reduces a decrease in the discharge capacity and also suppresses the gas generation due to the decomposition reaction of the electrolytic solution even upon repeated charging and discharging.

The nitrile compound is a compound including one or more cyano groups (—CN). Specific examples of the nitrile compound include octanenitrile, benzonitrile, phthalonitrile, succinonitrile, glutaronitrile, adiponitrile, cebaconitrile, 1,3,6-hexanetricarbonitrile, 3,3′-oxydipropionitrile, 3-butoxypropionitrile, ethylene glycol bispropionitrile ether, 1,2,2,3-tetracyanopropane, tetracyanopropane, fumaronitrile, 7,7,8,8-tetracyanoquinodimethane, cyclopentanecarbonitrile, 1,3,5-cyclohexanetricarbonitrile, and 1,3-bis(dicyanomethylidene)indane.

Note that the cyanated cyclic carbonic acid ester described above is excluded from the nitrile compound described here.

When manufacturing the electrolytic solution, the electrolyte salt is added to the solvent, following which the fluorine-containing aromatic ring compound is added to the solvent. The electrolyte salt and the fluorine-containing aromatic ring compound are each thereby dissolved or dispersed in the solvent. As a result, the electrolytic solution is prepared.

According to the electrolytic solution, the electrolytic solution includes the fluorine-containing aromatic ring compound.

In this case, the satisfactory film derived from the fluorine-containing aromatic ring compound is formed on the surface of the electrode as described above, unlike when the electrolytic solution includes no fluorine-containing aromatic ring compound and when the electrolytic solution includes another compound. This suppresses the decomposition reaction of the electrolytic solution on the surface of the electrode upon charging and discharging of the secondary battery including the electrolytic solution, which reduces a decrease in the discharge capacity even upon repeated charging and discharging. Accordingly, it is possible to achieve a superior battery characteristic of the secondary battery including the electrolytic solution.

Note that the “other compound” described above is a compound that has a structure similar to a structure of the fluorine-containing aromatic ring compound. Specific examples of the “other compound” include respective compounds represented by Formulae (51) and (52).

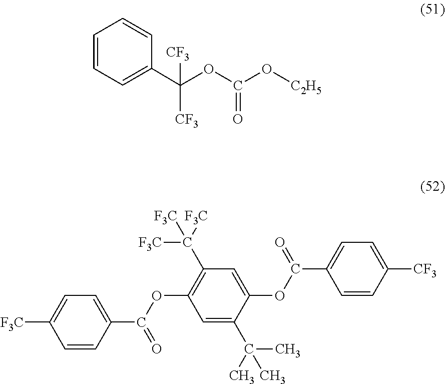 [SMILES: CCOC(=O)OC(c1ccccc1)(C(F)(F)F)C(F)(F)F ; CC(C)(C)c1cc(OC(=O)c2ccc(C(F)(F)F)cc2)c(C(C(F)(F)F)(C(F)(F)F)C(F)(F)F)cc1OC(=O)c1ccc(C(F)(F)F)cc1]

In particular, the introduction group may be either the amino-type group or the nitro group. This makes it easier for the film derived from the fluorine-containing aromatic ring compound to be formed. Accordingly, it is possible to achieve higher effects.

Further, the center part of the fluorine-containing aromatic ring compound may include two or more benzene rings, and the trifluoromethyl group and the introduction group may each be bonded to each of the two or more benzene rings. This makes it easier for the film derived from the fluorine-containing aromatic ring compound to be formed. As a result, the decomposition reaction of the electrolytic solution is easily suppressed. Accordingly, it is possible to achieve higher effects.

Further, the content of the fluorine-containing aromatic ring compound in the electrolytic solution may be within the range from 0.5 wt % to 2.0 wt % both inclusive. This makes it easier for the film derived from the fluorine-containing aromatic ring compound to be formed. As a result, the decomposition reaction of the electrolytic solution is easily suppressed. Accordingly, it is possible to achieve higher effects.

Further, the electrolytic solution may include any one or more of the unsaturated cyclic carbonic acid ester, the fluorinated cyclic carbonic acid ester, or the cyanated cyclic carbonic acid ester. This further suppresses the decomposition reaction of the electrolytic solution. Accordingly, it is possible to achieve higher effects.

Further, the electrolytic solution may include any one or more of the sulfonic acid ester, the sulfuric acid ester, the sulfurous acid ester, the dicarboxylic acid anhydride, the disulfonic acid anhydride, or the sulfonic acid carboxylic acid anhydride. This further suppresses the decomposition reaction of the electrolytic solution. Accordingly, it is possible to achieve higher effects.

Further, the electrolytic solution may include the nitrile compound. This further suppresses the decomposition reaction of the electrolytic solution and also suppresses the gas generation due to the decomposition reaction of the electrolytic solution. Accordingly, it is possible to achieve higher effects.

Further, the electrolytic solution may include the lactone as the high-dielectric-constant solvent, and the proportion R may be within the range from 30 wt % to 100 wt % both inclusive. This suppresses the gas generation due to the decomposition reaction of the electrolytic solution while securing the discharge capacity even upon repeated charging and discharging of the secondary battery. As a result, safety improves while a cyclability characteristic is secured. Accordingly, it is possible to achieve higher effects.

A description is given next of a secondary battery including the electrolytic solution described above according to an embodiment.

The secondary battery to be described here is a secondary battery in which a battery capacity is obtained through insertion and extraction of an electrode reactant, and includes a positive electrode, a negative electrode, and an electrolytic solution.

In the secondary battery, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

The electrode reactant is not particularly limited in kind, and is specifically a light metal such as an alkali metal or an alkaline earth metal. The alkali metal is, for example, lithium, sodium, or potassium. The alkaline earth metal is, for example, beryllium, magnesium, or calcium.

Examples are given below of a case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

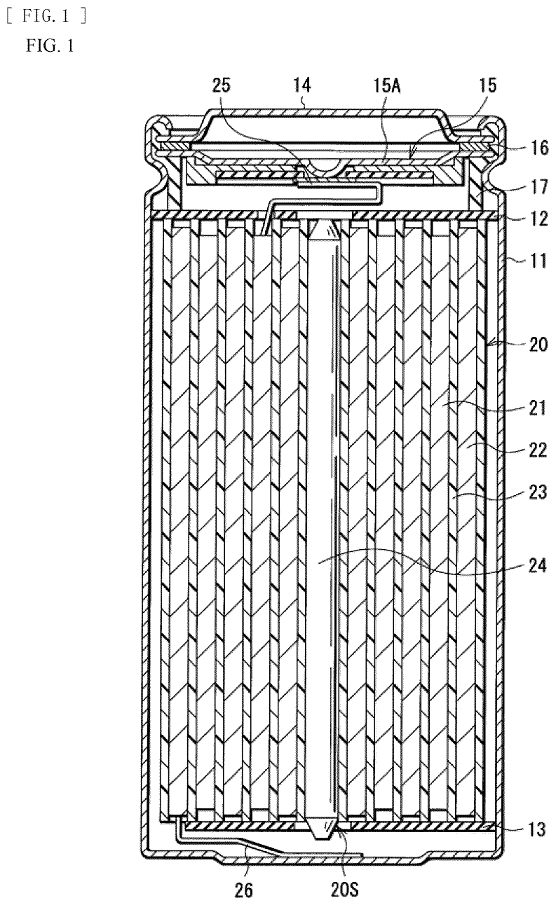

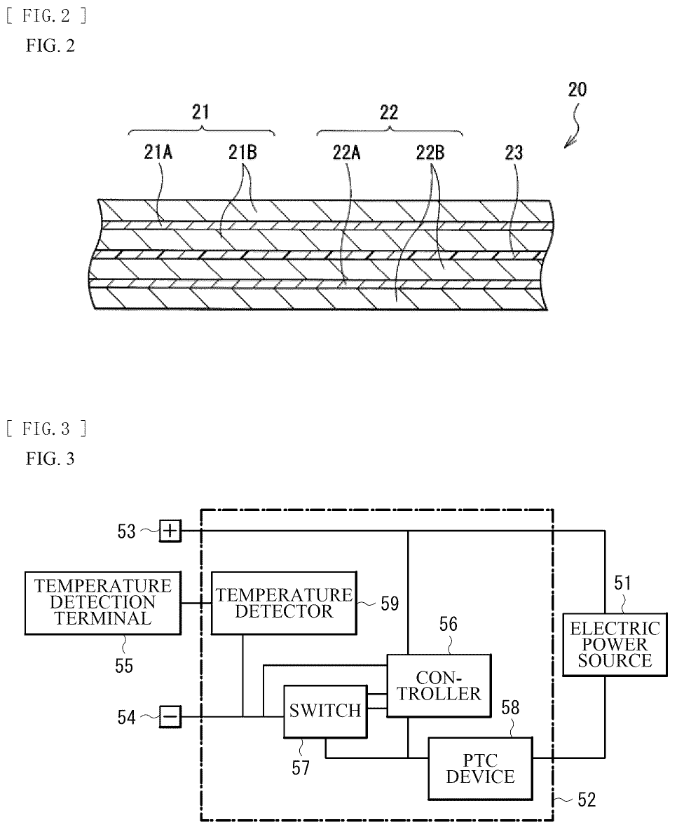

FIG. 1 illustrates a sectional configuration of the secondary battery. FIG. 2 illustrates a sectional configuration of a battery device 20 illustrated in FIG. 1. Note that FIG. 2 illustrates only a portion of the battery device 20.

As illustrated in FIGS. 1 and 2, the secondary battery mainly includes a battery can 11, a pair of insulating plates 12 and 13, the battery device 20, a positive electrode lead 25, and a negative electrode lead 26. The secondary battery described here is a secondary battery of a cylindrical type in which the battery device 20 is contained inside the battery can 11 having a cylindrical shape.

As illustrated in FIG. 1, the battery can 11 is a container member that contains the battery device 20 and other components. The battery can 11 has one end part that is open and another end part that is closed, and thus has a hollow structure. Further, the battery can 11 includes any one or more of metal materials including, without limitation, iron, aluminum, an iron alloy, and an aluminum alloy. Note that the battery can 11 may have a surface plated with a metal material such as nickel.

A battery cover 14, a safety valve mechanism 15, and a thermosensitive resistive device (a PTC device) 16 are crimped at the open end part of the battery can 11 by means of a gasket 17. The battery can 11 is thereby sealed by the battery cover 14. Here, the battery cover 14 includes a material similar to the material included in the battery can 11. The safety valve mechanism 15 and the PTC device 16 are each disposed on an inner side of the battery cover 14. The safety valve mechanism 15 is electrically coupled to the battery cover 14 via the PTC device 16. The gasket 17 includes an insulating material. The gasket 17 may have a surface on which a material such as asphalt is applied.

When an internal pressure of the battery can 11 reaches a certain level or higher as a result of a cause such as an internal short circuit or heating from outside, a disk plate 15A in the safety valve mechanism 15 inverts, thereby cutting off electrical coupling between the battery cover 14 and the battery device 20. An electric resistance of the PTC device 16 increases in accordance with a rise in temperature, in order to prevent abnormal heat generation resulting from a large current.

As illustrated in FIG. 1, the insulating plates 12 and 13 are so provided as to be opposed to each other with the battery device 20 interposed therebetween. The battery device 20 is thereby sandwiched between the insulating plates 12 and 13.

As illustrated in FIGS. 1 and 2, the battery device 20 is a power generation device that includes a positive electrode 21, a negative electrode 22, a separator 23, and the electrolytic solution (not illustrated).

The battery device 20 is what is called a wound electrode body. That is, the positive electrode 21 and the negative electrode 22 are stacked on each other with the separator 23 interposed therebetween, and are wound, being opposed to each other with the separator 23 interposed therebetween. A center pin 24 is disposed in a winding center space 20S provided at a winding center of the battery device 20. However, the center pin 24 may be omitted.

The positive electrode 21 includes, as illustrated in FIG. 2, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

Here, the positive electrode active material layer 21B is provided on each of the two opposed surfaces of the positive electrode current collector 21A, and includes any one or more of positive electrode active materials into which lithium is insertable and from which lithium is extractable. Note that the positive electrode active material layer 21B may be provided only on one of the two opposed surfaces of the positive electrode current collector 21A on a side where the positive electrode 21 is opposed to the negative electrode 22. Further, the positive electrode active material layer 21B may further include any one or more of other materials including, without limitation, a positive electrode binder and a positive electrode conductor. A method of forming the positive electrode active material layer 21B is not particularly limited, and specifically includes a method such as a coating method.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically, for example, an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, and LiMn₂O₄. Specific examples of the phosphoric acid compound include LiFePO₄, LiMnPO₄, and LiFe_{0.5}Mn_{0.5}PO₄.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material. Specific examples of the carbon material include graphite, carbon black, acetylene black, and Ketjen black. Note that the electrically conductive material may be a metal material or a polymer compound, for example.

The negative electrode 22 includes, as illustrated in FIG. 2, a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

Here, the negative electrode active material layer 22B is provided on each of the two opposed surfaces of the negative electrode current collector 22A, and includes any one or more of negative electrode active materials into which lithium is insertable and from which lithium is extractable. Note that the negative electrode active material layer 22B may be provided only on one of the two opposed surfaces of the negative electrode current collector 22A on a side where the negative electrode 22 is opposed to the positive electrode 21. Further, the negative electrode active material layer 22B may further include any one or more of other materials including, without limitation, a negative electrode binder and a negative electrode conductor. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

The negative electrode active material is not particularly limited in kind, and specific examples thereof include a carbon material and a metal-based material. A reason for this is that a high energy density is obtainable. Specific examples of the carbon material include graphitizable carbon, non-graphitizable carbon, and graphite (natural graphite and artificial graphite). The metal-based material is a material including, as one or more constituent elements, any one or more elements among metal elements and metalloid elements that are each able to form an alloy with lithium. Specific examples of such metal elements and metalloid elements include silicon and tin. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Details of the negative electrode binder are similar to those of the positive electrode binder. Details of the negative electrode conductor are similar to those of the positive electrode conductor.

As illustrated in FIG. 2, the separator 23 is an insulating porous film interposed between the positive electrode 21 and the negative electrode 22, and allows a lithium ion to pass therethrough while preventing contact (a short circuit) between the positive electrode 21 and the negative electrode 22. The separator 23 includes a polymer compound such as polyethylene.

The positive electrode 21, the negative electrode 22, and the separator 23 are each impregnated with the electrolytic solution, and the electrolytic solution has the configuration described above. That is, the electrolytic solution includes the fluorine-containing aromatic ring compound.

As illustrated in FIGS. 1 and 2, the positive electrode lead 25 is coupled to the positive electrode current collector 21A of the positive electrode 21, and includes an electrically conductive material such as aluminum. The positive electrode lead 25 is electrically coupled to the battery cover 14 via the safety valve mechanism 15.

As illustrated in FIGS. 1 and 2, the negative electrode lead 26 is coupled to the negative electrode current collector 22A of the negative electrode 22, and includes an electrically conductive material such as nickel. The negative electrode lead 26 is electrically coupled to the battery can 11.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon the charging and discharging, lithium is inserted and extracted in an ionic state.

When manufacturing the secondary battery, the positive electrode 21 and the negative electrode 22 are fabricated, and the secondary battery is fabricated using the positive electrode 21, the negative electrode 22, and the electrolytic solution, following which a stabilization process of the secondary battery is performed, according to an example procedure to be described below. Note that the procedure for preparing the electrolytic solution is as described above.

First, a mixture (a positive electrode mixture) in which the positive electrode active material, the positive electrode binder, and the positive electrode conductor are mixed with each other is put into a solvent to thereby prepare a positive electrode mixture slurry in paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Thereafter, the positive electrode active material layers 21B may be compression-molded by means of, for example, a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode 22 is formed by a procedure similar to the fabrication procedure of the positive electrode 21 described above. Specifically, first, a mixture (a negative electrode mixture) in which the negative electrode active material, the negative electrode binder, and the negative electrode conductor are mixed with each other is put into a solvent to thereby prepare a negative electrode mixture slurry in paste form. Thereafter, the negative electrode mixture slurry is applied on the two opposed surfaces of the negative electrode current collector 22A to thereby form the negative electrode active material layers 22B. Thereafter, the negative electrode active material layers 22B may be compression-molded. The negative electrode active material layers 22B are thus formed on the two respective opposed surfaces of the negative electrode current collector 22A. As a result, the negative electrode 22 is fabricated.

First, the positive electrode lead 25 is coupled to the positive electrode current collector 21A of the positive electrode 21 by a joining method such as a welding method, and the negative electrode lead 26 is coupled to the negative electrode current collector 22A of the negative electrode 22 by a joining method such as a welding method. Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated) having the winding center space 20S. The wound body has a configuration similar to that of the battery device 20 except that the positive electrode 21, the negative electrode 22, and the separator 23 are each not impregnated with the electrolytic solution. Thereafter, the center pin 24 is placed in the winding center space 20S of the wound body.

Thereafter, the wound body is sandwiched between the insulating plates 12 and 13, and in that state, the wound body and the insulating plates 12 and 13 are placed inside the battery can 11. In this case, the positive electrode lead 25 is coupled to the safety valve mechanism 15 by a joining method such as a welding method, and the negative electrode lead 26 is coupled to the battery can 11 by a joining method such as a welding method. Thereafter, the electrolytic solution is injected into the battery can 11 to thereby impregnate the wound body with the electrolytic solution. Thus, the positive electrode 21, the negative electrode 22, and the separator 23 are each impregnated with the electrolytic solution, and the battery device 20 is fabricated as a result.

Lastly, the battery cover 14, the safety valve mechanism 15, and the PTC device 16 are placed inside the battery can 11, following which the battery can 11 is crimped by means of the gasket 17. Thus, the battery cover 14, the safety valve mechanism 15, and the PTC device 16 are fixed to the battery can 11, and the battery device 20 is sealed in the battery can 11. As a result, the secondary battery is assembled.

The assembled secondary battery is charged and discharged. Various conditions including, for example, an environment temperature, the number of times of charging and discharging (the number of cycles), and charging and discharging conditions may be set as desired. As a result, a film is formed on the surface of each of the positive electrode 21 and the negative electrode 22, which electrochemically stabilizes a state of the secondary battery. In this case, the film derived from the fluorine-containing aromatic ring compound is formed as described above. As a result, the secondary battery is completed.

According to the secondary battery, the secondary battery includes the electrolytic solution, and the electrolytic solution has the above-described configuration. In this case, the decomposition reaction of the electrolytic solution upon charging and discharging is suppressed for the reason described above, which reduces a decrease in the discharge capacity even upon repeated charging and discharging. Accordingly, it is possible to achieve a superior battery characteristic.

In particular, the secondary battery may include a lithium-ion secondary battery. This makes it possible to obtain a sufficient battery capacity stably through insertion and extraction of lithium. Accordingly, it is possible to achieve higher effects.

Other action and effects of the secondary battery are similar to those of the electrolytic solution described above.

The configuration of the secondary battery described above is appropriately modifiable including as described below according to an embodiment. Note that any two or more of the following series of modifications may be combined with each other.

The description has been given of the case where the secondary battery has a battery structure of the cylindrical type. However, although not specifically illustrated here, a kind of the battery structure is not particularly limited, and may be, for example, a laminated-film type, a prismatic type, a coin type, or a button type.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. A reason for this is that adherence of the separator to each of the positive electrode 21 and the negative electrode 22 improves to suppress misalignment (winding displacement) of the battery device 20. This suppresses swelling of the secondary battery even if, for example, the decomposition reaction of the electrolytic solution occurs. The polymer compound layer includes a polymer compound such as polyvinylidene difluoride. A reason for this is that the polymer compound such as polyvinylidene difluoride is superior in physical strength and superior in electrochemical stability.

Note that the porous film, the polymer compound layer, or both may each include any one or more kinds of insulating particles. A reason for this is that the insulating particles promote heat dissipation upon heat generation by the secondary battery, thus improving safety or heat resistance of the secondary battery. The insulating particles include an inorganic material, a resin material, or both. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, insulating particles may be added to the precursor solution on an as-needed basis.

When the separator of the stacked type is used also, a lithium ion is movable between the positive electrode 21 and the negative electrode 22, and similar effects are therefore obtainable. In this case, in particular, the secondary battery improves in safety, as described above. Accordingly, it is possible to achieve higher effects.

The electrolytic solution, which is a liquid electrolyte, is used. However, although not specifically illustrated here, an electrolyte layer, which is a gel electrolyte, may be used.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

When the electrolyte layer is used also, a lithium ion is movable between the positive electrode 21 and the negative electrode 22 via the electrolyte layer, and similar effects are therefore obtainable. In this case, in particular, the leakage of the electrolytic solution is prevented, as described above. Accordingly, it is possible to achieve higher effects.

Applications (application examples) of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, and may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a single battery, or may each include an assembled battery. The electric vehicle is a vehicle that operates (travels) with the secondary battery as a driving power source, and may be a hybrid automobile that is additionally provided with a driving source other than the secondary battery. In the electric power storage system for home use, electric power accumulated in the secondary battery that is an electric power storage source may be utilized for using, for example, home appliances.

An application example of the secondary battery will now be described in detail. The configuration of the application example described below is merely an example, and is appropriately modifiable.

FIG. 3 illustrates a block configuration of a battery pack. The battery pack described here is a battery pack (what is called a soft pack) including one secondary battery, and is to be mounted on, for example, electronic equipment typified by a smartphone.

As illustrated in FIG. 3, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a PTC device 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.20 V±0.05 V. The overdischarge detection voltage is not particularly limited, and is specifically 2.40 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge/discharge control upon abnormal heat generation or when the controller 56 performs a correction process upon calculating a remaining capacity.

### EXAMPLES

A description is given of Examples of the present technology according to an embodiment.

### Examples 1 to 21 and Comparative Examples 1 to 3

Secondary batteries were manufactured, following which the secondary batteries were each evaluated for a battery characteristic as described below.

### [Manufacturing of Secondary Battery]

The lithium-ion secondary batteries of the cylindrical type illustrated in FIGS. 1 and 2 were manufactured in accordance with the following procedure.

### (Fabrication of Positive Electrode)

First, 91 parts by mass of the positive electrode active material (lithium cobalt oxide (LiCoO₂) as the lithium-containing compound (the oxide)), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into a solvent (N-methyl-2-pyrrolidone as the organic solvent), following which the solvent was stirred to thereby prepare a positive electrode mixture slurry in paste form. Thereafter, the positive electrode mixture slurry was applied on the two opposed surfaces of the positive electrode current collector 21A (a band-shaped aluminum foil having a thickness of 12 m) by means of a coating apparatus, following which the applied positive electrode mixture slurry was dried to thereby form the positive electrode active material layers 21B. Lastly, the positive electrode active material layers 21B were compression-molded by means of a roll pressing machine. In this manner, the positive electrode 21 was fabricated.

### (Fabrication of Negative Electrode)

First, 93 parts by mass of the negative electrode active material and 7 parts by mass of the negative electrode binder (polyvinylidene difluoride) were mixed with each other to thereby obtain a negative electrode mixture. Used as the negative electrode active material was a mixture of 63 parts by mass of artificial graphite as the carbon material and 30 parts by mass of silicon oxide (SiO) as the metal-based material. Thereafter, the negative electrode mixture was put into a solvent (N-methyl-2-pyrrolidone as the organic solvent), following which the solvent was stirred to thereby prepare a negative electrode mixture slurry in paste form. Thereafter, the negative electrode mixture slurry was applied on the two opposed surfaces of the negative electrode current collector 22A (a band-shaped copper foil having a thickness of 15 m) by means of a coating apparatus, following which the applied negative electrode mixture slurry was dried to thereby form the negative electrode active material layers 22B. Lastly, the negative electrode active material layers 22B were compression-molded by means of a roll pressing machine. In this manner, the negative electrode 22 was fabricated.

### (Preparation of Electrolytic Solution)

The electrolyte salt (LiPF₆ as the lithium salt) was added to the solvent (ethylene carbonate as the cyclic carbonic acid ester and dimethyl carbonate as the chain carbonic acid ester), following which the solvent was stirred. A mixture ratio (a weight ratio) between ethylene carbonate and dimethyl carbonate in the solvent was set to 20:80. A content of the electrolyte salt was set to 1.2 mol/kg with respect to the solvent. Thereafter, the fluorine-containing aromatic ring compound was added to the solvent to which the electrolyte salt was added, following which the solvent was stirred. A kind of the fluorine-containing aromatic ring compound was as presented in Table 1. As a result, the electrolytic solution was prepared.

An electrolytic solution for comparison was prepared by a similar procedure, except that no fluorine-containing aromatic ring compound was used. In addition, an electrolytic solution for comparison was prepared by a similar procedure, except that the other compound was used instead of the fluorine-containing aromatic ring compound. A kind of the other compound was as presented in Table 1.

### (Assembly of Secondary Battery)

First, the positive electrode lead 25 (an aluminum foil) was welded to the positive electrode current collector 21A of the positive electrode 21, and the negative electrode lead 26 (a copper foil) was welded to the negative electrode current collector 22A of the negative electrode 22.

Thereafter, the positive electrode 21 and the negative electrode 22 were stacked on each other with the separator 23 (a fine-porous polyethylene film having a thickness of 15 m) interposed therebetween, following which the stack of the positive electrode 21, the negative electrode 22, and the separator 23 was wound to thereby fabricate the wound body having the winding center space 20S. Thereafter, the center pin 24 was placed in the winding center space 20S of the wound body.

Thereafter, the wound body was placed inside the battery can 11 together with the insulating plates 12 and 13. In this case, the positive electrode lead 25 was welded to the safety valve mechanism 15, and the negative electrode lead 26 was welded to the battery can 11. Thereafter, the electrolytic solution was injected into the battery can 11. The wound body was thereby impregnated with the electrolytic solution, and the battery device 20 was thus fabricated.

Lastly, the battery cover 14, the safety valve mechanism 15, and the PTC device 16 were placed inside the battery can 11, following which the battery can 11 was crimped by means of the gasket 17. Thus, the battery can 11 was sealed. As a result, the secondary battery was assembled.

### (Stabilization of Secondary Battery)

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of that value, 4.2 V, until a current reached 0.05 C. Upon discharging, the secondary battery was discharged with a constant current of 0.1 C until the voltage reached 3.0 V. Note that 0.1 C was a value of a current that caused a battery capacity (a theoretical capacity) to be completely discharged in 10 hours, and 0.05 C was a value of a current that caused the battery capacity to be completely discharged in 20 hours. As a result, the secondary battery was completed.

After the completion of the secondary battery, the content (wt %) of the fluorine-containing aromatic ring compound in the electrolytic solution and a content (wt %) of the other compound in the electrolytic solution were measured by ICP optical emission spectroscopy. The results of the measurement were as listed in Table 1.

### [Evaluation of Battery Characteristic]

The secondary batteries were each evaluated for a cyclability characteristic as the battery characteristic in accordance with the following procedure, and the evaluation revealed the results presented in Table 1.

First, the secondary battery was charged in a high-temperature environment (at a temperature of 50° C.), following which the charged secondary battery was left standing (for a standing time of 3 hours) in the same environment. Upon charging, the secondary battery was charged with a constant current of 1 C until a voltage reached 4.2 V, and was thereafter charged with a constant voltage of that value, 4.2 V, until a current reached 0.05 C. Note that 1 C was a value of a current that caused the battery capacity to be completely discharged in 1 hour.

Thereafter, the secondary battery was discharged in the same environment to thereby measure a discharge capacity (a first-cycle discharge capacity). Upon discharging, the secondary battery was discharged with a constant current of 3 C until the voltage reached 3.0 V. Note that 3 C was a value of a current that caused the battery capacity to be completely discharged in ⅓ hours.

Thereafter, the secondary battery was repeatedly charged and discharged in the same environment until the number of cycles reached 100 to thereby measure the discharge capacity (a 100th-cycle discharge capacity). Charging and discharging conditions of the second and subsequent cycles were similar to the charging and discharging conditions of the first cycle.

Lastly, a capacity retention rate that was an index for evaluating the cyclability characteristic was calculated based on the following calculation expression: capacity retention rate (%)=(100th-cycle discharge capacity/first-cycle discharge capacity)×100.

TABLE 1

| | Fluorine- | | | | |
|---|---|---|---|---|---|
| | containing aromatic | | | | |
| | ring compound | | Other compound | | Capacity |
| | | Content | | Content | retention |
| | Kind | (wt %) | Kind | (wt %) | rate (%) |
| Example 1 | Formula (1) | 0.2 | — | — | 60 |
| Example 2 | | 0.5 | — | — | 68 |
| Example 3 | | 1.0 | — | — | 69 |
| Example 4 | | 1.5 | — | — | 69 |
| Example 5 | | 2.0 | — | — | 65 |
| Example 6 | | 3.0 | — | — | 59 |
| Example 7 | Formula (2) | 1.5 | — | — | 67 |
| Example 8 | Formula (3) | 1.5 | — | — | 68 |
| Example 9 | Formula (4) | 1.5 | — | — | 70 |
| Example 10 | Formula (13) | 1.5 | — | — | 68 |
| Example 11 | Formula (16) | 1.5 | — | — | 69 |
| Example 12 | Formula (23) | 1.5 | — | — | 68 |
| Example 13 | Formula (24) | 1.5 | — | — | 66 |
| Example 14 | Formula (30) | 1.5 | — | — | 65 |
| Example 15 | Formula (31) | 1.5 | — | — | 66 |
| Example 16 | Formula (34) | 1.5 | — | — | 65 |
| Example 17 | Formula (35) | 1.5 | — | — | 66 |
| Example 18 | Formula (36) | 1.5 | — | — | 68 |
| Example 19 | Formula (39) | 1.5 | — | — | 68 |
| Example 20 | Formula (40) | 1.5 | — | — | 69 |
| Example 21 | Formula (41) | 1.5 | — | — | 67 |
| Comparative | — | — | — | — | 42 |
| example 1 | | | | | |
| Comparative | — | — | Formula (51) | 1.5 | 43 |
| example 2 | | | | | |
| Comparative | — | — | Formula (52) | 1.5 | 46 |
| example 3 | | | | | |

As indicated in Table 1, the capacity retention rate varied depending on the configuration of the electrolytic solution.

Specifically, when the electrolytic solution included the other compound (Comparative examples 2 and 3), the capacity retention rate increased only slightly, as compared with when the electrolytic solution included neither the fluorine-containing aromatic ring compound nor the other compound (Comparative example 1).

In contrast, when the electrolyte solution included the fluorine-containing aromatic ring compound (Examples 1 to 21), the capacity retention rate increased greatly, as compared with when the electrolytic solution included neither the fluorine-containing aromatic ring compound nor the other compound (Comparative example 1).

In particular, when the electrolytic solution included the fluorine-containing aromatic ring compound, the following tendencies were obtained. When the introduction group was either the amino-type group or the nitro group, the capacity retention rate further increased. When the content of the fluorine-containing aromatic ring compound in the electrolytic solution was within the range from 0.5 wt % to 2.0 wt % both inclusive, the capacity retention rate further increased.

### Examples 22 to 27

Secondary batteries were fabricated by a procedure similar to that in Example 4, except that the additive (the unsaturated cyclic carbonic acid ester, the fluorinated cyclic carbonic acid ester, or the cyanated cyclic carbonic acid ester) was included in the electrolytic solution as indicated in Table 2, following which the secondary batteries were each evaluated for a battery characteristic. A classification, a kind, and a content (wt %) of the additive were as listed in Table 2.

Specifically, used as the unsaturated cyclic carbonic acid ester was vinylene carbonate (VC). Used as the fluorinated cyclic carbonic acid ester was fluoroethylene carbonate (FEC). Used as the cyanated cyclic carbonic acid ester was cyanoethylene carbonate (CEC).

TABLE 2

| | Fluorine-containing | | | | | |
|---|---|---|---|---|---|---|
| | aromatic ring | | | | | Capacity |
| | compound | | Additive | | | retention |
| | | Content | | | Content | rate |
| | Kind | (wt %) | Classification | Kind | (wt %) | (%) |
| Example 4 | Formula (1) | 1.5 | — | — | — | 69 |
| Example 22 | | | Unsaturated | VC | 1.0 | 75 |
| Example 23 | | | cyclic carbonic | | 5.0 | 75 |
| | | | acid ester | | | |
| Example 24 | | | Fluorinated | FEC | 1.0 | 75 |
| Example 25 | | | cyclic carbonic | | 5.0 | 78 |
| | | | acid ester | | | |
| Example 26 | | | Cyanated | CEC | 1.0 | 76 |
| Example 27 | | | cyclic carbonic | | 5.0 | 77 |
| | | | acid ester | | | |

As indicated in Table 2, when the electrolytic solution included the additive (the unsaturated cyclic carbonic acid ester, the fluorinated cyclic carbonic acid ester, or the cyanated cyclic carbonic acid ester) (Examples 22 to 27), the capacity retention rate further increased, as compared with when the electrolytic solution included no additive (Example 4).

### Examples 28 to 45

Secondary batteries were fabricated by a procedure similar to that in Example 4, except that the additive (the sulfonic acid ester, the sulfuric acid ester, the sulfurous acid ester, the dicarboxylic acid anhydride, the disulfonic acid anhydride, or the sulfonic acid carboxylic acid anhydride) was included in the electrolytic solution as indicated in Table 3, following which the secondary batteries were each evaluated for a battery characteristic. The classification, the kind, and the content (wt %) of the additive were as listed in Table 3.

Specifically, used as the sulfonic acid ester were 1,3-propane sultone (PS), 1-propene-1,3-sultone (PRS), 1,4-butane sultone (BS1), 2,4-butane sultone (BS2), and methanesulfonate propargyl ester (MSP).

Used as the sulfuric acid ester were 1,3,2-dioxathiolane 2,2-dioxide (OTO), 1,3,2-dioxathiane 2,2-dioxide (OTA), and 4-methylsulfonyloxymethyl-2,2-dioxo-1,3,2-dioxathiolane (SOTO).

Used as the sulfurous acid ester were 1,3,2-dioxathiolane 2-oxide (DTO) and 4-methyl-1,3,2-dioxathiolane 2-oxide (MDTO).

Used as the dicarboxylic acid anhydride were 1,4-dioxane-2,6-dione (DOD), succinic anhydride (SA), and glutaric anhydride (GA).

Used as the disulfonic acid anhydride were 1,2-ethanedisulfonic anhydride (ESA), 1,3-propanedisulfonic anhydride (PSA), and hexafluoro 1,3-propanedisulfonic anhydride (FPSA).

Used as the sulfonic acid carboxylic acid anhydride were 2-sulfobenzoic anhydride (SBA) and 2,2-dioxooxathiolane-5-one (DOTO).

TABLE 3

| | Fluorine-containing | | | | | |
|---|---|---|---|---|---|---|
| | aromatic ring | | | | | Capacity |
| | compound | | Additive | | | retention |
| | | Content | | | Content | rate |
| | Kind | (wt %) | Classification | Kind | (wt %) | (%) |
| Example 4 | Formula (1) | 1.5 | — | — | — | 69 |
| Example 28 | | | Sulfonic acid | PS | 1.0 | 75 |
| Example 29 | | | ester | PRS | 1.0 | 73 |
| Example 30 | | | | BS1 | 1.0 | 72 |
| Example 31 | | | | BS2 | 1.0 | 72 |
| Example 32 | | | | MSP | 1.0 | 76 |
| Example 33 | | | Sulfuric acid | OTO | 1.0 | 74 |
| Example 34 | | | ester | OTA | 1.0 | 73 |
| Example 35 | | | | SOTO | 1.0 | 74 |
| Example 36 | | | Sulfurous acid | DTO | 1.0 | 75 |
| Example 37 | | | ester | MDTO | 1.0 | 74 |
| Example 38 | | | Dicarboxylic | DOD | 1.0 | 72 |
| Example 39 | | | acid anhydride | SA | 1.0 | 72 |
| Example 40 | | | | GA | 1.0 | 72 |
| Example 41 | | | Disulfonic acid | ESA | 1.0 | 77 |
| Example 42 | | | anhydride | PSA | 1.0 | 78 |
| Example 43 | | | | FPSA | 1.0 | 74 |
| Example 44 | | | Sulfonic acid | SBA | 1.0 | 74 |
| Example 45 | | | carboxylic acid | DOTO | 1.0 | 75 |
| | | | anhydride | | | |

As indicated in Table 3, when the electrolytic solution included the additive (the sulfonic acid ester, the sulfuric acid ester, the sulfurous acid ester, the dicarboxylic acid anhydride, the disulfonic acid anhydride, or the sulfonic acid carboxylic acid anhydride) (Examples 28 to 45′), the capacity retention rate further increased, as compared with when the electrolytic solution included no additive (Example 4).

### Examples 46 to 63

Secondary batteries were fabricated by a procedure similar to that in Example 4, except that the additive (the nitrile compound) was included in the electrolytic solution as indicated in Table 4, following which the secondary batteries were each evaluated for a battery characteristic. The classification, the kind, and the content (wt %) of the additive were as listed in Table 4.

Specifically, used as the nitrile compound were octanenitrile (ON), benzonitrile (BN), phthalonitrile (PN), succinonitrile (SN), glutaronitrile (GN), adiponitrile (AN), cebaconitrile (SBN), 1,3,6-hexanetricarbonitrile (HCN), 3,3′-oxydipropionitrile (OPN), 3-butoxypropionitrile (BPN), ethylene glycol bispropionitrile ether (EGPN), 1,2,2,3-tetracyanopropane (TCP), tetracyanoethylene (TCE), fumaronitrile (FN), 7,7,8,8-tetracyanoquinodimethane (TCQ), cyclopentanecarbonitrile (CPCN), 1,3,5-cyclohexanetricarbonitrile (CHCN), and 1,3-bis(dicyanomethylidene)indane (BCMI).

Here, safety was evaluated as a battery characteristic in addition to the cyclability characteristic. In a case of examining the safety, the secondary battery was stored in a high-temperature environment (at a temperature of 80° C.), following which a time (operation time) taken for the safety valve mechanism 15 to operate due to an increase in the internal pressure of the battery can 11 was measured. The operation time was an index for evaluating the safety (a gas generation characteristic), or a parameter representing what is called a gas generation suppression degree. That is, the longer the operation time, the longer the time taken for the safety valve mechanism 15 to operate. The longer operation time thus meant that the gas generation due to the decomposition reaction of the electrolytic solution inside the battery can 11 was suppressed more.

Note that the values of the operation time listed in Table 4 were values normalized with respect to the operation time measured in Example 4 assumed to be 1.0.

Here, an increase in the internal pressure of the battery can 11 indicated that the decomposition reaction of the electrolytic solution occurred inside the battery can 11, and thus gas was generated due to the decomposition reaction of the electrolytic solution. Further, the operation of the safety valve mechanism 15 indicated that electrical coupling between the battery cover 14 and the battery device 20 was cut off.

TABLE 4

| | Fluorine-containing | | | | | | |
|---|---|---|---|---|---|---|---|
| | aromatic ring | | | | | | |
| | compound | | Additive | | | Capacity | Operation |
| | | Content | | | Content | retention | time |
| | Kind | (wt %) | Classification | Kind | (wt %) | rate | (normalized) |
| Example 4 | Formula (1) | 1.5 | — | — | — | 69 | 1.00 |
| Example 46 | | | Nitrile | ON | 0.5 | 69 | 1.30 |
| Example 47 | | | compound | BN | 0.5 | 68 | 1.20 |
| Example 48 | | | | PN | 0.5 | 67 | 1.20 |
| Example 49 | | | | SN | 0.5 | 69 | 1.60 |
| Example 50 | | | | GN | 0.5 | 67 | 1.60 |
| Example 51 | | | | AN | 0.5 | 68 | 1.60 |
| Example 52 | | | | SBN | 0.5 | 70 | 1.40 |
| Example 53 | | | | HCN | 0.5 | 69 | 1.60 |
| Example 54 | | | | OPN | 0.5 | 68 | 1.30 |
| Example 55 | | | | BPN | 0.5 | 67 | 1.20 |
| Example 56 | | | | EGPN | 0.5 | 69 | 1.60 |
| Example 57 | | | | TCP | 0.5 | 68 | 1.60 |
| Example 58 | | | | TCE | 0.5 | 67 | 1.20 |
| Example 59 | | | | FN | 0.5 | 67 | 1.60 |
| Example 60 | | | | TCQ | 0.5 | 68 | 1.20 |
| Example 61 | | | | CPCN | 0.5 | 69 | 1.30 |
| Example 62 | | | | CHCN | 0.5 | 68 | 1.20 |
| Example 63 | | | | BCMI | 0.5 | 68 | 1.10 |

As indicated in Table 4, when the electrolytic solution included the additive (the nitrile compound) (Examples 46 to 63), the operation time increased while a high capacity retention rate was maintained, as compared with when the electrolytic solution included no additive (Example 4).

### Examples 64 to 78

Secondary batteries were fabricated by a procedure similar to that in Example 4, except that the composition of the solvent was varied as indicated in Table 5, following which the secondary batteries were each evaluated for a battery characteristic.

A kind of the solvent, the mixture ratio (the content (wt %)) in the solvent, and the proportion R (wt %) were as presented in Table 5. Here, additionally used were: propylene carbonate (PC) as the high-dielectric-constant solvent (the cyclic carbonic acid ester); each of ethylmethyl carbonate (EMC) and diethyl carbonate (DEC) as the low-dielectric-constant solvent (the chain carbonic acid ester); and propyl propionate (PrPr) as the low-dielectric-constant solvent (the chain carboxylic acid ester). In this case, the kind of the solvent and the mixture ratio in the solvent were each varied to thereby vary the proportion R.

TABLE 5
Fluorine-containing aromatic ring compound (kind = Formula (1), content = 1.5 wt %)

| | | | Cyclic carbonic | | Chain carbonic | | Chain carboxylic | | | | |
|---|---|---|---|---|---|---|---|---|---|---|---|
| | Lactone | | acid ester | | acid ester | | acid ester | | | Capacity | Operation |
| | | Content | | Content | | Content | | Content | Proportion | retention | time |
| | Kind | (wt %) | Kind | (wt %) | Kind | (wt %) | Kind | (wt %) | R (wt %) | rate (%) | (normalized) |
| Example 4 | — | — | EC | 20 | DMC | 80 | — | — | 0 | 69 | 1.00 |
| Example 64 | GBL | 10 | EC | 10 | DMC | 80 | — | — | 50 | 67 | 1.25 |
| Example 65 | GBL | 4 | EC | 16 | DMC | 80 | — | — | 20 | 68 | 1.10 |
| Example 66 | GBL | 6 | EC | 14 | DMC | 80 | — | — | 30 | 68 | 1.20 |
| Example 67 | GBL | 20 | — | — | DMC | 80 | — | — | 100 | 67 | 1.80 |
| Example 68 | GBL | 15 | EC | 15 | EMC + DEC | 35 + 35 | — | — | 50 | 67 | 1.50 |
| Example 69 | GBL | 15 | EC | 15 | DEC | 35 | PrPr | 35 | 50 | 67 | 1.60 |
| Example 70 | — | — | EC | 30 | EMC + DEC | 35 + 35 | — | — | 0 | 69 | 1.03 |
| Example 71 | GBL | 6 | EC | 24 | EMC + DEC | 35 + 35 | — | — | 20 | 68 | 1.10 |
| Example 72 | GBL | 9 | EC | 21 | EMC + DEC | 35 + 35 | — | — | 30 | 67 | 1.25 |
| Example 73 | GBL | 30 | — | — | EMC + DEC | 35 + 35 | — | — | 100 | 67 | 1.80 |
| Example 74 | GBL | 40 | — | — | EMC + DEC | 20 + 20 | PrPr | 20 | 100 | 66 | 1.80 |
| Example 75 | — | — | EC + PC | 20 + 20 | EMC + DEC | 20 + 20 | PrPr | 20 | 0 | 69 | 1.08 |
| Example 76 | GBL | 20 | EC + PC | 10 + 10 | EMC + DEC | 20 + 20 | PrPr | 20 | 50 | 66 | 1.60 |
| Example 77 | — | — | EC + PC | 50 + 50 | — | — | — | — | 0 | 69 | 1.08 |
| Example 78 | GBL | 100 | — | — | — | — | — | — | 100 | 67 | 2.00 |

As indicated in Table 5, a high capacity retention rate was obtained even if the composition of the solvent was varied (Examples 64 to 78). In this case, when the electrolytic solution included the high-dielectric-constant solvent (the lactone) and the proportion R was within the range from 30 wt % to 100 wt % both inclusive in particular (for example, Example 64), the operation time further increased while a high capacity retention rate was maintained.

Based upon the results presented in Tables 1 to 5, when the electrolytic solution included the fluorine-containing aromatic ring compound, a high capacity retention rate was obtained. Therefore, the cyclability characteristic improved. Accordingly, it was possible to achieve a superior battery characteristic of the secondary battery including the electrolytic solution.

Although the present technology has been described above with reference to some embodiments and Examples, the configuration of the present technology is not limited to those described with reference to the embodiments and Examples above, and is therefore modifiable in a variety of ways.

Specifically, the description has been given of the case where the battery device has a device structure of a wound type. However, the device structure of the battery device is not particularly limited, and may be of any other type such as a stacked type or a zigzag folded type. In the stacked type, the positive electrode and the negative electrode are alternately stacked on each other with the separator interposed therebetween. In the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution including a fluorine-containing aromatic ring compound, wherein
the fluorine-containing aromatic ring compound includes
a center part including one or more benzene rings,
one or more trifluoromethyl groups each represented by —CF₃ and introduced into the center part, and
one or more introduction groups introduced into the center part, and
each of the one or more introduction groups is any one of an amino-type group represented by —NR₂ where each of two R's is either a hydrogen group or a methyl group, a nitro group represented by —NO₂, a cyano group represented by —CN, or an isocyanate group represented by —NCO.

2. The secondary battery according to claim 1, wherein each of the one or more introduction groups is either the amino-type group or the nitro group.

3. The secondary battery according to claim 1, wherein
the center part includes two or more benzene rings, and
the one or more trifluoromethyl groups and the one or more introduction groups are introduced into each of the two or more benzene rings.

4. The secondary battery according to claim 1, wherein a content of the fluorine-containing aromatic ring compound in the electrolytic solution is greater than or equal to 0.5 weight percent and less than or equal to 2.0 weight percent.

5. The secondary battery according to claim 1, wherein the electrolytic solution further includes at least one of an unsaturated cyclic carbonic acid ester, a fluorinated cyclic carbonic acid ester, or a cyanated cyclic carbonic acid ester.

6. The secondary battery according to claim 1, wherein the electrolytic solution further includes at least one of a sulfonic acid ester, a sulfuric acid ester, a sulfurous acid ester, a dicarboxylic acid anhydride, a disulfonic acid anhydride, or a sulfonic acid carboxylic acid anhydride.

7. The secondary battery according to claim 1, wherein the electrolytic solution further includes a nitrile compound.

8. The secondary battery according to claim 1, wherein
the electrolytic solution includes a high-dielectric-constant solvent having a specific dielectric constant of greater than or equal to 20 at a temperature within a range of higher than or equal to 30 degrees Celsius and lower than 60 degrees Celsius,
the high-dielectric-constant solvent includes a lactone, and
a proportion of a weight of the lactone to a weight of the high-dielectric-constant solvent is greater than or equal to 30 weight percent and less than or equal to 100 weight percent.

9. The secondary battery according to claim 1, wherein the secondary battery comprises a lithium-ion secondary battery.

10. An electrolytic solution for a secondary battery, the electrolytic solution comprising:
a fluorine-containing aromatic ring compound, wherein
the fluorine-containing aromatic ring compound includes
a center part including one or more benzene rings,
one or more trifluoromethyl groups each represented by —CF₃ and introduced into the center part, and
one or more introduction groups introduced into the center part, and
each of the one or more introduction groups is any one of an amino-type group represented by —NR₂ where each of two R's is either a hydrogen group or a methyl group, a nitro group represented by —NO₂, a cyano group represented by —CN, or an isocyanate group represented by —NCO.
